(19) United States
(12) Patent Application Publication
(10) Pub. No.: US 2012/0255796 A1
(43) Pub. Date: Oct. 11, 2012

(54) SAFETY WEIGHT INDICATOR

(76) Inventor: Ronnie Lynn BUCKNER, Odessa, TX (US)

(21) Appl. No.: 13/441,219

(22) Filed: Apr. 6, 2012

Related U.S. Application Data
(60) Provisional application No. 61/473,204, filed on Apr. 8, 2011.

(51) Int. Cl. G01G 19/10

(52) U.S. Cl. 177/1; 177/141

(57) ABSTRACT

A method and device for a safety weight indicator for a gin pole truck, the indicator having a a hydraulic tension load cell, the tension load cell further having a top end fastened to a brace at the top of an A frame comprised of gin poles, and the load cell further having a bottom end through which a hook of a first sheave communicates, the first sheave further suspending a cable supporting a load, the indicator further having a pressure converting gauge calibrated to convert a hydraulic signal into pounds of weight, and a hose communicating changes in levels of hydraulic fluid from the load cell to the pressure converting gauge.

### CROSS REFERENCE TO RELATED APPLICATIONS

This application claims the benefit of provisional patent application 61/473,204 filed Apr. 8, 2011 by the present inventor and the same is incorporated by reference herein in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE DISCLOSED TECHNOLOGY

1. Field of the Invention

The following disclosure relates generally to devices and methods for calculating and monitoring weight and load on heavy equipment, and specifically to a safety weight indicator for a gin pole truck.

2. Description of Related Art

The general concept of load calculators and indicators are well known with regard to heavy lifting machinery such as cranes. This is primarily because crane operators are required to have operator certifications incorporating load calculation knowledge requirements and because cranes are required to be load rated. Although the legislation and insurance carriers have regulated crane safety for some time, the carriers are only just now beginning to regulate load ratings and indicators with regard to gin pole trucks.

With regard to cranes, load moment indicators assist the operators to stay within safe load limits. Crane load indicators, also known as load moment indicators, show what the crane is rated for, what the current load is, and other load and safety related variables. Each component of the truck's lifting system affects what the maximum load will be, including the distance the load is being lifted from the truck center.

With regard to gin pole trucks, however, the concept of a load indicator must be employed much differently. Gin pole trucks are typically of an A frame construction. Two parallel gin poles are mounted in the truck bed at fixed angles to each other. The poles create an A frame because the bottom of each pole resides on one side of the bed of the truck (creating a wide base) and the top of the two poles are joined together at their top (creating a narrow top or apex)(there may be an intervening brace or component joining the tops of the two poles together). A pulley (sheave) extends down from the apex of the poles and the load is suspended from this via a cable running over the sheave. The system comprises one or more additional pulleys and cables which run from a winch in the rear bed of the truck to the suspended load. Unlike cranes, the majority of gin pole trucks utilize a mechanically driven winch.

The structure of a gin pole truck is much different than that of a crane in that there are multiple angles created by the system of sheaves and the angle of the gin poles (A frame). As a result, it is not possible to take an off the shelf scale or dynamometer and use it to accurately assess the pull of a load on a gin pole truck set up. The concept of creating a load indicator for a mechanically driven winch on a gin pole truck does not appear to have ever been attempted.

Although new insurance regulations now require gin pole trucks to have weight certifications and certified operators, there is currently no method or device for enabling these requirements. As a result, oil and gas drilling companies are being forced to upgrade their equipment from gin pole trucks to cranes. This is a quite costly and burdensome solution that is not fiscally practical.

There is a need for a practical method and device to calculate and monitor weight and load for a gin pole truck. There is a need for a practical method and device to enable weight certifications and operator certifications with regard to gin pole trucks. The method and device should be relatively inexpensive and practical to incorporate into existing gin pole truck design.

### SUMMARY OF THE INVENTION

In accordance with the present invention, a device and method is disclosed for calculating the weight of a load carried on a gin pole truck.

An objective of the disclosure is a device and method that enables an operator to easily determine how much weight is supported on the load of a gin pole truck.

An objective of the disclosure is a device and method that alerts an operator when the load limits of a gin pole truck are being approached.

An objective of the disclosure is a device and method a permanently mounted device to enable weight certifications of gin pole trucks.

An objective of the disclosure is a method and device for calculating the weight in a load held by a mechanically driven winch.

An objective of the disclosure is a device and method for enabling operator certifications for gin pole truck operators.

An objective of the disclosure is a device and method for increasing the safety surrounding a gin pole truck carrying a load.

An objective of the disclosure is a safety weight indicator for a gin pole truck, the indicator comprising a hydraulic tension load cell, the tension load cell having a top end fastened to a brace at the top of an A frame comprised of gin poles, and the load cell further having a bottom end through which a hook of a first sheave communicates, the first sheave further suspending a cable supporting a load; a pressure converting gauge calibrated to convert a hydraulic signal into pounds of weight, and a hose communicating changes in levels of hydraulic fluid from the load cell to the pressure converting gauge.

An objective of the disclosure is a method for measuring a safety weight for a gin pole truck, the method comprising mounting a hydraulic tension load cell, the tension load cell having a top end fastened to a brace at the top of an A frame comprised of gin poles, and the load cell further having a bottom end through which a hook of a first sheave communicates, the first sheave further suspending a cable supporting a load; calibrating a pressure converting gauge to convert a hydraulic signal into pounds of weight, and using a hose to communicate changes in levels of hydraulic fluid from the load cell to the pressure converting gauge.

An objective of the disclosure is a method for rating the load of a gin pole truck, the method comprising positioning a hydraulic tension load cell below the apex of an A frame of gin poles and above a sheave over which runs a cable supporting a load, calibrating a pressure converting gauge to convert a hydraulic signal to pounds of weight, placing a first end of a hose into communication with hydraulic fluid in the tension load cell and placing a second end of the hose in communication with the gauge.

An objective of the disclosure is a method to accurately determine the weight on gin poles of a load, taking into account the winch, sheaves, cables and the angles of the poles the method including mounting a tension load cell below the apex of the A frame, communicating one end of a hydraulic hose to the hydraulic piston of the tension load cell, mathematically calculating calibrations and constructing a gauge to incorporate the calibrations and convert the hydraulic reading into pounds of weight.

Other advantages of the present invention will become apparent from the following descriptions, taken in connection with the accompanying figures, wherein, by way of illustration and example, an embodiment of the present invention is disclosed.

### BRIEF DESCRIPTION OF THE DRAWINGS

The figures constitute a part of this specification and include exemplary embodiments to the invention, which may be embodied in various forms. It is to be understood that in some instances various aspects of the invention may be shown exaggerated or enlarged to facilitate an understanding of the invention. To enable more thorough understanding of the features and advantages of the present invention, reference is now made to the detailed description of the invention along with the accompanying figures in which:

FIG. 1 is a perspective view of the preferred embodiment of the disclosed invention, in place on the gin pole truck.

FIG. 2 is a close up view of the preferred embodiment of the disclosed invention, revealing an indicator gauge.

FIG. 3 is a close up view of the preferred embodiment of the disclosed invention, revealing a tension load cell.

FIG. 4 is a close up of the tension load cell and hydraulic hose.

FIG. 5 is a close up of the face of a pressure converting gauge as described herein.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Currently, with regard to gin pole trucks, not only does the operator not know the weight of the load he is carrying, but he also does not know what his vehicle is rated for, nor if his load is within the range of what the truck can safely accommodate. As a result, the disclosed method and device is anticipated to become mandatory safety equipment. With the disclosed, the operator can, from the safety of the cab of his truck, be able to monitor the load and verify that the load is within the safety rating for that particular vehicle.

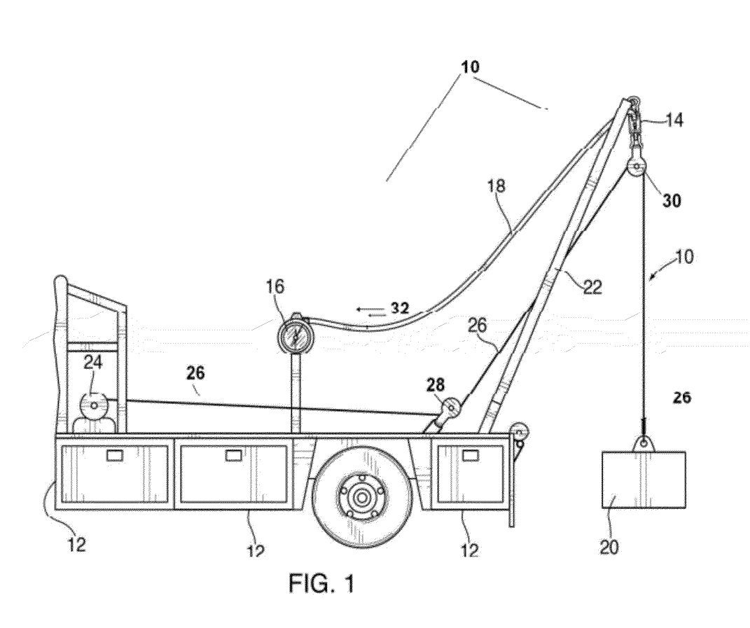

Turning to the illustrations, as exhibited in FIG. 1, in a preferred embodiment, the disclosed device 10 is pictured in place on a gin pole truck 12. The device 10 enables accurate measurements in pounds of weight, rather than pressure, of what the operator is picking up with his truck 12. The device 10 incorporates (when used on a gin pole truck having a mechanically driven winch, one or more cables and sheaves) a hydraulic load signal converter which in the preferred embodiment is a hydraulic tension load cell 14, a pressure converting gauge, which in the preferred embodiment is a gauge 16 modified to convert a hydraulic signal into pounds of weight and a hose 18 communicating from the load cell 14 to the gauge 16, the hose carrying hydraulic fluid and communicating the changes in hydraulic fluid levels in the load cell to the gauge. In FIG. 1, it is shown that the cable has a first end attached to a winch 24, travels through two sheaves and has a second end supporting the load 20.

In practice, as the gin pole truck 12 moves into position to hook up the load 20, the operator extends the poles 22 for lifting the load 20. The winch 24 reels out the winch cable 26 under a first sheave 28 and up over a second sheave 30 and then down to the load 20. The load 20 is suspended from the cable 26 and the winch 24 then begins to reel the cable 26 up, thus taking the weight of the load 20 onto the sheaves and the poles 22. Above the second sheave 30, and below the apex of the A frame, is a tension load cell 14 that registers the load 20 suspended from the second sheave 30 by a hydraulic piston inside the load cell 14, converting it into a hydraulic signal. As the load 20 pulls down from the load cell 14, hydraulic fluid 32 is transferred through the hydraulic hose 18 to the pressure converting gauge 16.

The pressure converting gauge 16 reads the pressure of the tension load cell 30 and gives an accurate value of the weight the gin pole truck set up is picking up. The indicator gauge 16 has been constructed for this specific purpose. It is a pressure gauge that has had components modified (the internal tube, dial face and needle placement) in order to read in pounds of weight rather than in pounds of pressure. The disclosed gauge is novel, in that the gauge has been specifically constructed and calibrated to read accurately as to the weight of the load, taking into account the sheaves, cable system and the angles of the poles.

To achieve an accurate reading required a multi-step process. First, to mount the hydraulic hose and the tension load cell in specific positions in order to take into account the weight bearing upon the winch as well as the weight bearing upon the pulleys and the gin poles. Second, to mathematically calculate calibrations that reflected the weight distribution accurately. Third, to construct a gauge that would incorporate the calibrations and convert the hydraulic reading into pounds of weight.

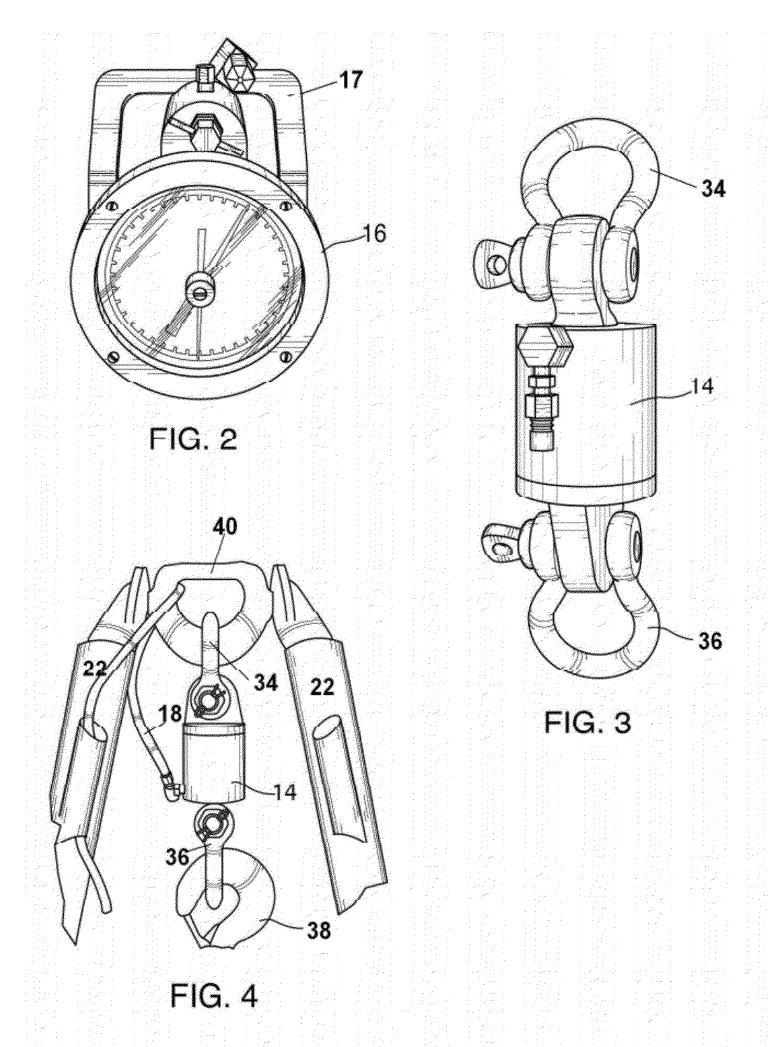

FIG. 2 depicts a closure up of the pressure converting indicator gauge 16. The indicator gauge 16 utilizes a bourdon tube internally to measure the pressure. A bourdon tube is known technology incorporating a flattened thin-wall, closed-end tube which is connected at the hollow end to a fixed pipe containing the fluid pressure to be measured. As the pressure increases, the closed end moves in an arc, and this motion is converted into the rotation of a (segment of a) gear by a connecting link. The gauge further comprises a dampener to keep the needle firmer. This type of gauge, being liquid filled, also results in a more stationery needle placement than other types of gauges that are dry.

The mounting bracket 17 of the gauge and the gauge 16 itself are such that, in a preferred embodiment, the gauge may be moved around as needed, for example, to be removably mounted in the cab of the truck, on the side of the truck bed, or to be carried by hand as needed. The hydraulic hose is intended to be long enough to allow for this mobility of the gauge, for example at least 25 feet and no more than 50 feet long, with a preferred length of 35 feet.

The gauge may also employ a safety alarm feature to sound or visually show an alarm should the safety load maximums be approached.

FIG. 3 depicts a close up view of the tension load cell 14. The tension load cell 14 has fixed to its top end a first clevis fastener 34 which attaches to a brace that connects the gin poles 22 to create the top of the A frame. The tension load cell 14 has fixed to its bottom end a second clevis fastener 36 through which the hook 38 of the hook type cable puller second sheave 30 communicates.

FIG. 4 depicts in more detail the placement of the components, showing where, in the preferred embodiment, the hydraulic hose 18 communicates with the tension load cell 14, the first clevis fastener 34 of the tension load cell 14 being attached to the brace 40 connecting the two gin poles 22 to create the A frame of the truck. The second clevis fastener 36 is at the bottom end of the tension load cell 14 and through it travels the hook 38 of the second sheave 30.

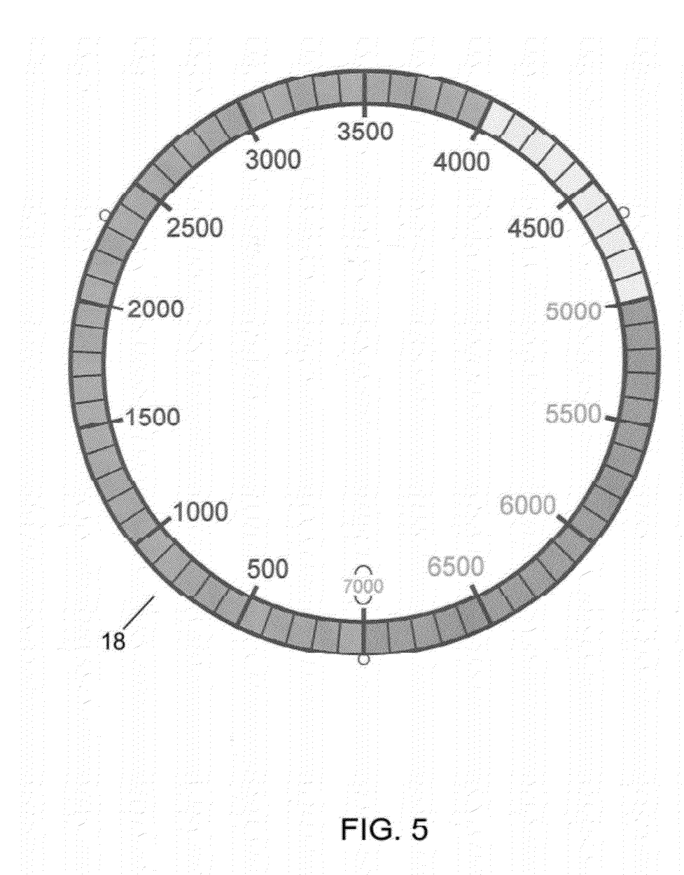

FIG. 5 shows the face of the indicator gauge 16, revealing the amount of pounds in increments of five hundred, although the increments could be modified depending upon the application. The gauge may, in an embodiment, be marked to indicate the maximum allowable weight of the vehicle. It is pictured herein as analog but could, if modified, to achieve the objectives described herein, potentially be electric or digital.

The use of the disclosed device allows the operator to know in real time how much the load weighs on his gin pole truck and prevents the operator from picking up more weight than the truck is rated for. An advantage of the disclosed is that it is a permanently mounted system rather than a type of scale or dynamometer that has to be hooked on each time the operator wishes to check load. It is safer, more efficient and more effective to have the system in place at all times.

The unique design of the device enables the hydraulic hose to be of various lengths such that it may extend all the way into the cab of the truck (or anywhere else on the vehicle) where it is attached to the indicator gauge. This portability enables the operator to see the gauge from the comfort and convenience of his cab or it can be hung on a bracket on the side of truck during operations. It is a reliable and effective safety implement that allows the operator to quickly know whether he is lifting a load that falls within the certified load parameters of his vehicle.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It is to be understood that the embodiments disclosed herein are shown for illustrative purposes and are not intended to be construed as limitations of the disclosed method and system. Those skilled in the art will recognize or be able to ascertain in the course of routine experimentation, that variations and equivalents of the embodiments may be undertaken without departing from the scope of the invention.

Certain terms are used throughout the description to refer to particular method components. As one skilled in the art will appreciate, design and manufacturing companies may refer to a component by different names. This document does not intend to distinguish between components that differ in name but not function.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

The word “sheave” may be used interchangeably with the word “pulley” herein and refers to one or more wheels or rollers with a groove along its edge for holding a belt, rope or cable. When hung between two supports and equipped with a belt, rope or cable, one or more sheaves make up a pulley.

The use of the word “a” or “an” when used in conjunction with the word “comprising” may mean “one”, or may also mean “one or more.” The use of the term “or” in the claims is used to mean “and/or” unless explicitly indicated to refer to alternatives only or the alternatives are mutually exclusive, although the disclosures supports a definition that refers to only alternatives and “and/or.”

The methods and systems disclosed and claimed herein can be made and executed without undue experimentation based on the level of disclosure presented. While the methods and systems have been described in terms of their preferred embodiments, it will be apparent to those skilled in the art that they are not limited to the exact steps described and may vary from such description without departing from the scope and spirit of the invention. The substitutes and modifications employed by one skilled in the art are deemed to fall within the scope of the invention.

What is claimed is:

1. A safety weight indicator for a gin pole truck, the indicator comprising:
a hydraulic tension load cell, the tension load cell having a top end fastened to a brace at the top of an A frame comprised of gin poles, and the load cell further having a bottom end through which a hook of a first sheave communicates, the first sheave further suspending a cable supporting a load;
a pressure converting gauge calibrated to convert a hydraulic signal into pounds of weight, and
a hose communicating changes in levels of hydraulic fluid from the load cell to the pressure converting gauge.

2. The indicator of claim 1 wherein the cable further has a first end attached to a winch, travels through the first sheave and at least one second sheave mounted to a bed of the truck, and wherein the cable has a second end supporting the load.

3. The indicator of claim 1 wherein the gauge further comprises a safety alarm for sounding an alert when a maximum load is being approached.

4. The indicator of claim 1 wherein the gauge further comprises a bourdon tube.

5. The indicator of claim 1 wherein the gauge further comprises a dampener.

6. The indicator of claim 1 wherein the gauge is mounted in a cab of the truck.

7. The indicator of claim 1 wherein the gauge is mobile.

8. A method for measuring a safety weight for a gin pole truck, the method comprising:
mounting a hydraulic tension load cell, the tension load cell having a top end fastened to a brace at the top of an A frame comprised of gin poles, and the load cell further having a bottom end through which a hook of a first sheave communicates, the first sheave further suspending a cable supporting a load;
calibrating a pressure converting gauge to convert a hydraulic signal into pounds of weight, and
using a hose to communicate changes in levels of hydraulic fluid from the load cell to the pressure converting gauge.

9. The method of claim 8 wherein the cable further has a first end supporting the load, travels through the first sheave and at least one second sheave mounted to a bed of the truck, and wherein the cable has a second end attached to a winch.

10. The method of claim 8 wherein the gauge further comprises a safety alarm for sounding an alert when a maximum load is being approached.

11. The method of claim 8 wherein the gauge further comprises a bourdon tube.

12. The method of claim 8 wherein the gauge further comprises a dampener.

13. A method for rating the load of a gin pole truck, the method comprising:
positioning a hydraulic tension load cell below the apex of an A frame of gin poles and above a sheave over which runs a cable supporting a load;
calibrating a pressure converting gauge to convert a hydraulic signal to pounds of weight;
placing a first end of a hose into communication with hydraulic fluid in the tension load cell and placing a second end of the hose in communication with the gauge.
